(19) United States
(12) Patent Application Publication
(10) Pub. No.: US 2007/0140375 A1
(43) Pub. Date: Jun. 21, 2007

(54) Joint-source channel decoding method and associated joint source-channel decoder

(75) Inventors: Marion Jeanne, Rennes (FR); Pierre Siohan, Rennes (FR)

Correspondence Address: Thomas Langer;Cohen Pontani Lieberman & Pavane, Suite 1210, 551 Fifth Avenue, New York, NY, 10176, US

(73) Assignee: FRANCE TELECOM, PARIS (FR)

(21) Appl. No.: 10/594,254

(22) PCT Filed: Mar. 16, 2005
(86) PCT No.: PCT/FR05/00645

§ 371 Date: Sep. 25, 2006

(30) Foreign Application Priority Data
Mar. 25, 2004 (FR) 0450593

(51) Int. Cl. H04N 11/04; H04L 27/00

(52) U.S. Cl. 375/295; 375/240.01

(57) ABSTRACT

A method of combined source-channel decoding of digital data coding discrete values or symbols (i, j, etc.) received by a channel decoder (51) of a digital data decoder (50) from a source (10) over a transmission channel (40) wherein probabilities (p(i), p(i/j)) associated with said symbols are applied to a channel decoding trellis of said channel decoder (51). The probabilities are estimated statistically from occurrences of the symbols estimated by said decoder (50).

The present invention relates to a combined source-channel decoding method. It also relates to an associated combined source-channel decoder.

A particularly advantageous application of the invention is to coding and decoding digital data transmitted over a communications channel, in particular MPEG (Moving Picture Expert Group) data transmitted over UMTS mobile telephone channels.

The digital communications systems offering the best performance at present use source and channel coding systems that are optimized separately. The source coder minimizes the redundancy of the source signal to be transmitted. In contrast, the channel coder introduces controlled redundancy to protect the information from the interference that is inherent to any kind of transmission.

In concrete terms, the best audio, image, and video source coding results are obtained by discrete cosine transform (DCT) coders or wavelet coders associated with variable length codes (VLC). Where channel coding is concerned, turbocodes, and more generally soft decision iterative coders, represent a decisive step towards the theoretical limit defined by Shannon, but optimum separation of source coding and channel coding is guaranteed only for codes whose length tends towards infinity. Because of this, the optimum solutions achieved in practice, with channel codes of finite length, lead to optimizing combined source-channel coding and/or decoding systems.

Considerable work has been done on these systems recently, in particular on variable length codes which represent the most critical situation in that a single error can propagate over entire segments of the bit stream before the receiver is able to resynchronize. Several combined source-channel coding and/or decoding methods have been proposed. One of their common features is the necessity to use the source statistic to improve the overall performance of the decoder under given transmission conditions. Authors usually assume that the decoder knows this statistic exactly. In practice, this is not the case for real signals, especially for non-stationary source signals, as in the application to MPEG4 transmission over UMTS channels referred to above.

There are four prior art categories of solutions for decoding variable length codes, for example of the Huffman type, transmitted over degraded transmission channels known as noisy channels, with or without channel coding:

a) Separate Decoding or Tandem Method.

In that method channel and source decoding are effected sequentially and independently. Source decoding involves looking up information in tables and therefore corresponds to what is referred to as hard decoding. In that case, the coder and the decoder need only to know the variable length code table and the decoder requires no additional source statistic information. Tandem decoding using hard source decoding is the standard decoding scheme in prior art communications systems. European patent 1 230 736 refers to tandem decoding with turbocoding used for channel coding.

b) Decoding Methods with Perfect Estimation of the Source.

Those methods assume that the decoder knows perfectly and definitively the structure of the variable length code tree and the associated source statistic, made up of discrete values (symbols). That statistic may be used by the source decoder, in a form of decoding known as flexible decoding, and/or by the channel decoder. In this regard, above-mentioned European patent 1 230 736 constitutes a significant advance in terms of channel decoding taking account of the source statistic.

c) Decoding Methods with Parametric Estimation of the Source.

Parametric modeling of real sources may be envisaged in some cases. For example, in the paper by A. H. Murad and T. E. Fuja, “Exploiting the residual redundancy in motion estimation vectors to improve the quality of compressed video transmitted over noisy channels”, Proceedings of the Inter. Conf. on Image Processing (ICIP), 4-7 Oct. 1998, the authors propose a first order Markov model comprising eight parameters for representing the movement vectors of a sequence of animated images. The decoder can then use these parameters, which are estimated in the coder and assumed to be transmitted perfectly, to process the source statistic, i.e. the movement vector variable length code symbol transition probabilities.

d) Decoding Methods with Non-Parametric Estimation of the Source.

Decoding methods that dispense with a model are becoming more generic and can therefore be applied to different sources. The estimation methods known at present relate only to estimating symbol probabilities, either stationary probabilities (see J. Wen and J. D. Villasenor, “Utilizing Soft Information in decoding of Variable Length Codes”, Proceedings of DCC, Snowbird, Utah, USA, March 1999) or, and better, first order Markov source transition probabilities (see C. Weidmann and P. Siohan, “Décodage conjoint source-canal avec estimation en ligne de la source” [“Combined source-channel decoding with on-line estimation of the source”], Proceedings of Coresa 03, Lyon, France, January 2003).

That imposes the calculation of a number of stationary probabilities equal to the size of the alphabet of the source symbols or of transition probabilities equal to the square of the size of that alphabet. In practice, that therefore rules out transmitting said information and imposes estimation in the decoder. Accordingly, a simple calculation performed for the movement vectors of the MPEG4 coder shows that the transmission of the necessary statistics (a 65×65 matrix of real numbers for each block of 4096 bits) would require an unacceptable increase in the bit rate.

However, the above decoding methods all have a number of drawbacks.

Drawbacks of Methods of Type a).

The essential drawback of those methods is that they do not exploit a priori knowledge linked to the source for flexible source decoding or for channel decoding assisted by the source. However, considerable research based on assumptions of type b), c) or d) has shown that significant improvements could be obtained given exact knowledge or an estimate of the source statistic. Thus, for a given transmission scheme and a given channel, type a) methods constitute a lower limit in terms of performance.

Drawbacks of Methods of Type b).

Decoding methods that assume perfect knowledge of the source statistic in the decoder can be applied only in theoretical frameworks that are encountered relatively infrequently in practice. For a given transmission scheme and a given channel, type b) methods constitute an upper limit in terms of performance.

Drawbacks of Methods of Type c).

Decoding methods that use parametric estimation of the source are a first step toward practical applications. However, there are a number of omissions in the description of the method given in the above-mentioned paper by A. H. Murad et al.

Firstly, a criticism of a general nature is that the MAP (maximum a posteriori) decoding algorithm used is extremely complex in that it is implemented by means of a decoding trellis that corresponds to the product of three elementary decoding trellises.

As for the estimation method proper, it should be noted that the eight parameters estimated in the coder are assumed to be transmitted without error and only once. That assumption ignores the fact that such transmission has a high cost. Firstly, it increases the bit rate significantly because, in practice, the movement vectors constitute a source of non-stationary events, and the parameters of the model that change frequently must therefore be transmitted on each update. Then, the cost of protecting the information transmitted by the movement parameters by channel coding, because it is highly sensitive, may be high, while estimating it in the decoder can make the model less accurate. In this regard, it should be emphasized that, even in the coder, modeling the movement vectors is relatively complex, and in the above-mentioned paper by A. H. Murad et al. the authors themselves recognize the imperfection of their model. Moreover, that model does not really correspond to what happens in reality according to the video standards where, to reduce the bit rate, a differential mode is selected for coding the movement vectors, which makes obtaining an accurate model even more complex.

Drawbacks of Methods of Type d).

The above-mentioned paper by J. Wen and J. D. Villasenor is the first reference to non-parametric estimation of the source statistic in the decoder. To stop the propagation of errors, the data is encapsulated in packets and it is assumed that the decoder knows the number of bits per packet, which is generally the case. The number of symbols per packet may or may not be known. The algorithm used by those authors is of the flexible input and flexible output type: it provides information as to the confidence that can be placed on the selected sequence. Simulations using a Gaussian additive white noise channel show a significant improvement compared to hard decoding. In a second part of the paper, the authors consider estimating the source probabilities in the decoder. They derive a forward pass, backward pass algorithm close to the Baum-Welch algorithm, dedicated to estimating symbol probabilities in a variable length code context. Apart from the fact that that technique relates only to source decoding, its major drawback is linked to its great complexity. The decoder corresponds to the implementation of a general method of obtaining the optimum decoded sequence in the MAP sense. That approach is based on dynamic programming and offers no simplified implementation. Moreover, the method is limited to calculating stationary probabilities of different variable length code symbols and therefore takes no account of Markov sources, which are of greater interest from the point of view of potential improvements in performance.

More recently, the above-mentioned paper by C. Weidmann and P. Siohan has proposed a combined source-channel coding and/or decoding technique using a module in the source decoder to estimate the statistic for first order Markov sources. Note firstly that the combined source-channel coding and/or decoding principle is based on the serial turbocoding technique with a variable length code first coder. Decoding then applies the turbocoding principle between the channel decoder and a flexible variable length code decoder. That scheme was initially proposed by Bauer and Hagenauer for a source without memory and extended afterwards by Guyader et al. to Markov sources, based each time on an MAP criterion (symbol or sequence). The estimation method described in the above-mentioned paper by C. Weidmann and P. Siohan applies to that type of combined source-channel coding and/or decoding scheme. The source decoding portion is described in terms of a BCJR (Bahl Cocke Jellnek Raviv) algorithm using a trellis that functions at the bit and symbol level. It is then shown that a variant of the Baum-Welch algorithm expresses the estimate of the statistics of the source symbols using the BCJR forward and backward phase variables again.

Despite those simplifications, the method has the drawback of a very high complexity overhead.

Moreover, emerges in detail below, a comparison made with the assumption of perfect estimation of the source has shown that that iterative method offers worse performance than the method of the present invention for bit error rates (BER) of less than 10⁻³ that are most typical of mobile radio channels (see M. Jeanne, P. Siohan, J. C. Carlach, “Comparaison de deux approches du décodage combiné source-canal pour la transmission sans fil de vidéo” [“Comparison of two approaches to combined source-channel decoding for wireless transmission of video”], Proceedings of the Gretsi colloquium, September 2003).

The context of the present invention is methods of type d). Its object is to move towards, and even to achieve, optimum decoding performance, in the MAP sense, at the same time as retaining acceptable implementation complexity for mass market receiver systems, for example mobile telephones able to receive video signals.

A major drawback common to the two methods of type d) referred to above is linked to their great implementation complexity. The complexity overhead results largely from the fact that flexible source decoding or combined source-channel coding and/or decoding is effected at the symbol level.

In contrast, the present invention proposes a simple and effective method of estimating the source statistic of variable length code symbols that is integrated at the bit level. It is based on European patent 1 230 736, which already proposes a method of flexible source decoding or combined source-channel coding and/or decoding implemented at the bit level. In particular, it is shown in the above patent that a turbocode type decoding technique can greatly improve performance if the first channel decoder of the decoder uses both the knowledge of the variable length code tree structure and the statistics associated with the branches of the tree. Depending on the source model, the useful statistic may correspond to stationary probabilities or to transition probabilities. However, all the decoding options of the above-mentioned European patent (flexible source decoding, combined source-channel coding and/or decoding with convolutional codes or turbocodes) assume that the decoder knows the source statistic perfectly, which in practice is not generally the case.

The present invention therefore proposes to improve the method of European patent 1 230 736 by adding to it a simple method of estimating the source statistic.

According to the present invention, this is achieved by a method of combined source-channel decoding of digital data coding discrete values or symbols received by a channel decoder of a digital data decoder from a source over a transmission channel, wherein probabilities associated with said symbols are applied to a channel decoding trellis of said channel decoder, which method is characterized in that said probabilities are estimated statistically from occurrences of the symbols estimated by said decoder.

The main advantages of the coding method of the invention are as follows:

improved performance when decoding Markov sources coded with variable length codes; these improvements over a method of type a) are reflected in a lower BER (bit error rate) when transmitting on a given channel or conversely in the possibility of obtaining a given BER using a lower transmitted power,

for a given transmission system and a given channel, the possibility of obtaining results close to the upper limit of performance of methods of type b),

the possibility of using a source estimation method that is sufficiently generic to take account of sources of different kinds without increasing the transmission bit rate,

a method whose implementation complexity is relatively low compared to prior art methods of type d).

If i, j, etc. denote the symbols associated with the source by source coding, according to the invention said probabilities are the probabilities p(i) of occurrences of the symbols i or the probabilities p(i/j) of transitions between the symbols i and j. The probability p(i/j) (the probability of i “knowing” j) more precisely signifies the probability of the symbol i occurring after the symbol j.

According to the invention, said probabilities are estimated iteratively by accumulating estimated symbol information at the decoder output.

Finally, in an advantageous embodiment of the invention said symbols are coded using a variable length code represented by a binary tree of finite size and said probabilities are associated with each branch of said tree and applied to the corresponding stages of said channel decoding trellis.

In practical terms, the decoding method of the invention may be implemented by a combined source-channel decoder for digital data, comprising a channel decoder adapted to receive digital data transmitted from a source over a transmission channel and coding discrete values or symbols and probabilities associated with said symbols, which combined decoder is characterized in that it further comprises a generator of histograms of occurrences of the symbols estimated by the decoder, means for calculating probabilities associated with said restored symbols, and means for applying said probabilities to a channel decoder trellis of the channel decoder.

More particularly, said channel decoding trellis produces binary values and said means for applying said probabilities comprise a module for converting symbol probabilities into binary value probabilities.

The description with reference to the appended drawings, which are provided by way of non-limiting example, explains in what the invention consists and how it may be reduced to practice.

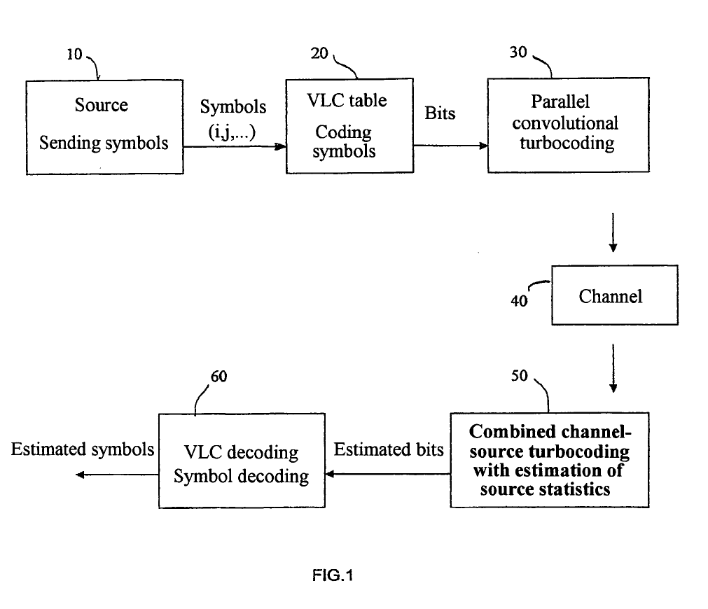

FIG. 1 is a general diagram of a system including a combined source-channel decoder of the invention used to code/decode digital data received from a source over a noisy transmission channel.

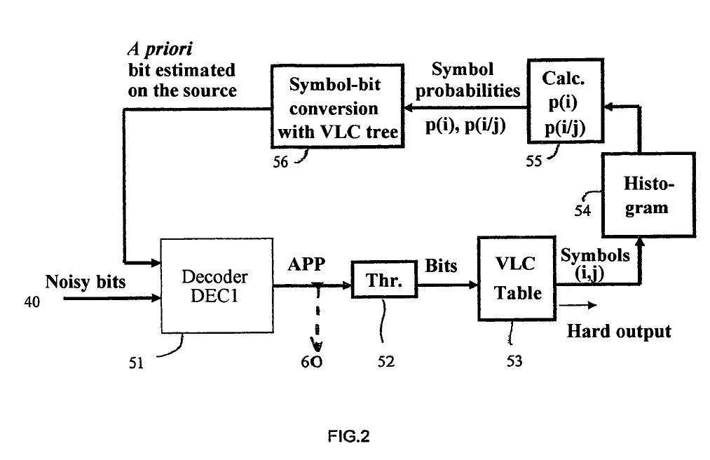

FIG. 2 is a general diagram of a combined source-channel decoder of the invention.

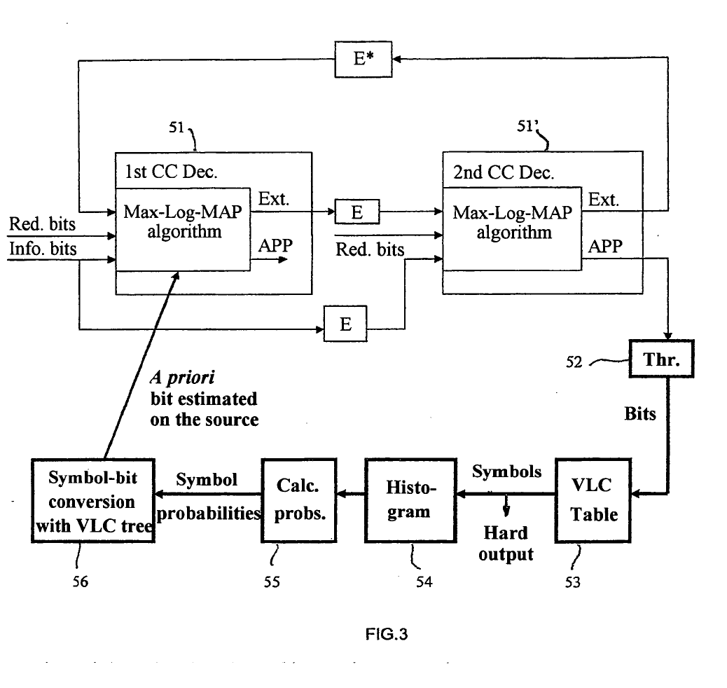

FIG. 3 is a detailed diagram of the FIG. 2 decoder in the case of turbocoding.

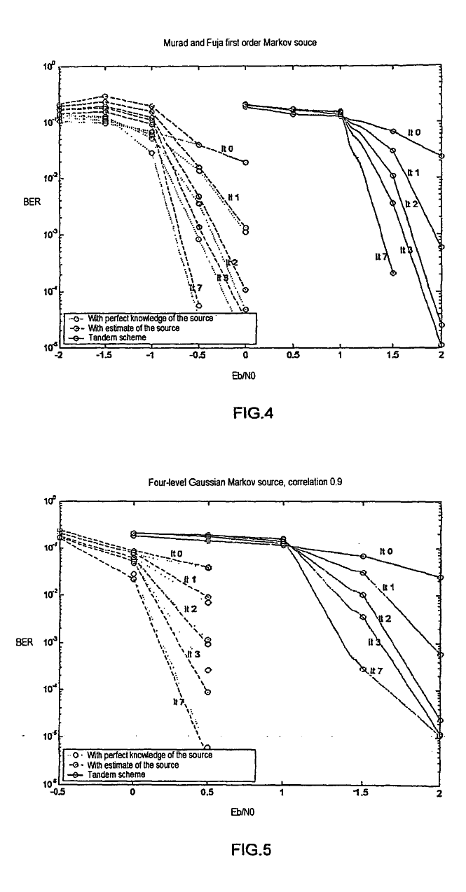

FIG. 4 is a comparative diagram giving the bit error rate (BER) as a function of the usable signal-to-noise ratio (Eb/NO) for the first order Markov source proposed by Murad and Fuja, using a tandem decoding method (dotted line), a combined source-channel coding and/or decoding method with perfect knowledge of the source (continuous line), and the combined source-channel coding and/or decoding method of the invention with estimation of the source (dashed line).

FIG. 5 is a comparative diagram giving the bit error rate (BER) as a function of the usable signal-to-noise ratio (Eb/N0) for a Gaussian Markov source quantized on four levels, with a correlation of 0.9, using a tandem decoding method (dotted line), a combined source-channel coding and/or decoding method with perfect knowledge of the source (continuous line), and the combined source-channel coding and/or decoding method of the invention with estimation of the source (dashed line).

FIG. 1 is a diagram representing the transmission of digital data from a sender consisting of elements 10, 20, 30 to a receiver or decoder stage consisting of elements 50, 60 over a transmission channel 40.

Said sender includes a source 10 of symbols i, j, etc. that can be generated independently, in which case the source is known as a source without memory, or in a dependent manner, for example according to a first order Markov model that reflects the link between two consecutive symbols. In a video coder, these symbols i, j, etc. may correspond to texture movement coefficients, for example, quantized to yield a certain number of discrete values.

Said source 10 is followed by a video coder 20 represented by a variable length code (VLC) table, for example that standardized in the MPEG4 video standard. This VLC table is used in the source 10 to code symbols as digital data.

Finally, channel coding, for example convolutional parallel turbocoding, is applied to digital data from the coder 20 to protect it against interference induced during its transmission over the channel 40.

The transmission channel 40 is a noisy channel modeled by a simple Gaussian additive white noise channel, for example.

The receiver or decoder stage includes a combined channel-source decoder 50 which estimates the source statistic. Digital data is fed from the combined decoder 50 to a VLC decoder 60, which could be that of the MPEG4 video decoder, to supply at the output of the decoder an estimate of the values of the symbols i, j, etc. from the source 10.

The combined channel-source decoder 50 shown in bold in FIG. 1 and the decoding method that it uses constitute the subject matter of the present invention.

The combined decoder 50 is described in more detail next with reference to FIG. 2.

The FIG. 2 diagram shows that the decoder 50 includes a channel decoder 51, preferably of the trellis type, adapted to produce flexible a posteriori probability (APP) information. A threshold 52 is applied to the noisy output data to restore said data to the form of digital data consisting of 0 bits and 1 bit. A table-based VLC decoder 53 transforms the received bits into symbols i, j, etc.

The statistics of the symbols i, j, etc. from the source are estimated iteratively by means of a histogram generator 54 for calculating symbol probabilities, which are either stationary probabilities p(i) in the case of a model without memory or transition probabilities p(i/j) in the case of a first order Markov model.

Note also the presence of a module 56 for symbol probability to bit probability conversion with the VLC tree adapted to inject bit level probabilities into the channel decoder 51. This converter module 56 is the same as the module used in European patent 1 230 736. However, in the context of the invention, as shown in FIG. 2, this module, preceded by the histogram generator 54, is used on each decoding iteration to estimate the source 10, in contrast to what is proposed in the above patent, where it is used only once, on the assumption that the channel decoder 51 knows the source probabilities.

FIG. 3 is a diagram of one particular embodiment of the combined decoder 50 from FIG. 2 in the context of channel coding using the turbocoding technique, this decoder including a second convolutional channel decoder 51′ in addition to the convolutional channel decoder 51, each of these convolution channel decoders being associated with a convolutional channel coder (FIG. 1 channel coder 30). The change from one of the channel

1. A method of combined source-channel decoding of digital data coding discrete values or symbols (i, j, etc.) received by a channel decoder (51) of a digital data decoder (50) from a source (10) over a transmission channel (40), comprising the steps of:
applying probabilities (p(i), p(i/j)) associated with said symbols to a channel decoding trellis of said channel decoder (51); and
statistically estimating said probabilities from occurrences of the symbols estimated by said decoder (50).

2. The combined decoding method according to claim 1, wherein said probabilities are estimated iteratively.

3. The combined decoding method according to claim 1, wherein probabilities are probabilities (p(i)) of occurrences of the symbols.

4. The combined decoding method according to claim 1, wherein said probabilities are probabilities (p(i/j)) of transitions between the symbols.

5. The combined decoding method according to claim 1, wherein said channel decoder (51) is a convolutional decoder associated with a convolutional channel coder.

6. The combined decoding method according to claim 1, wherein the decoder is a turbodecoder and said channel decoder is an input channel decoder (51) of said turbodecoder.

7. The combined decoding method according to claim 1, wherein said symbols are coded by variable length codes (VLC) represented by a binary tree of finite size and said probabilities (p(i), p(i/j)) are associated with each branch of said tree and applied to the corresponding stages of said channel decoding trellis.

8. A combined source-channel decoder for digital data, comprising:
a channel decoder (51) adapted to receive digital data transmitted from a source (10) over a transmission channel (40) and coding discrete values or symbols (i, j, etc.) and probabilities associated with said symbols;
a generator (54) of histograms of occurrences of the symbols estimated by the decoder (50);
means (55) for calculating probabilities (p(i), p(i/j)) associated with said restored symbols; and
means (56) for applying said probabilities to a channel decoder trellis of the channel decoder (51).

9. The combined decoder according to claim 8, wherein said channel decoding trellis produces binary values ((0, 1) or (−1, 1) considering modulation) and said means for applying said probabilities comprise a module (56) for converting symbol probabilities (p(i), p(i/j)) into probabilities of binary values ((0, 1) or (−1, 1)).

10. A The combined decoder according to claim 8, wherein said probabilities are probabilities (p(i)) of occurrences of the symbols.

11. The combined decoder according to claim 8, wherein said probabilities are probabilities (p(i/j)) of transitions between the symbols.

12. The combined decoder according to claim 8, wherein said channel decoder (51) is a convolutional decoder associated with a convolutional channel coder.

13. The combined decoder according to claim 8, wherein the decoder is a turbodecoder and said channel decoder is an input channel decoder (51) of said turbodecoder.

14. The combined decoder according to claim 8, wherein said symbols are coded by variable length codes (VLC) represented by a binary tree of finite size and said probabilities (p(i), p(i/j)) are associated with each branch of said tree and applied to the corresponding stages of said channel decoding trellis.
